(19) United States
(12) Patent Application Publication
(10) Pub. No.: US 2025/0093505 A1
(43) Pub. Date: Mar. 20, 2025

(54) Sensor For Monitoring A Zone

(71) Applicant: SICK AG, Waldkirch (DE)

(72) Inventors: Matthias HONAL, Wittnau (DE); Tiberius PISCHKE, Freiburg (DE); Raphael ENGESSER, Au (DE); Manuel AIPLE, Denzlingen (DE); Philipp KLEIN, Gutach im Breisgau (DE)

(21) Appl. No.: 18/883,652

(22) Filed: Sep. 12, 2024

(30) Foreign Application Priority Data
Sep. 14, 2023 (DE) 10 2023 124 838.3
Aug. 19, 2024 (EP) 24195138.3

(51) Int. Cl. G01S 17/04; G01S 7/48

(52) U.S. Cl. CPC G01S 17/04; G01S 7/4802

(57) ABSTRACT

A sensor for monitoring a zone with regard to the presence of at least one object includes a transmission device, a reception device and an evaluation device. The transmission device emits transmission signals into the zone to be monitored. The reception device receives detection signals that include those transmission signals that are reflected or remitted in the zone to be monitored. The evaluation device is configured to determine at least one measurement variable based on the detection signals related to at least one dimension of an object in the zone to be monitored, to determine and output an occupied state of the zone to be monitored if the at least one measurement variable is greater than an entry threshold value, and to determine and output a free state of the zone to be monitored if the at least one measurement variable is smaller than an exit threshold value.

The invention relates to a sensor that is provided to monitor a zone in the environment of the sensor with regard to the presence of at least one object.

In this respect, it can in particular be a lidar sensor (Light Detection and Ranging).

Such sensors for monitoring a specific areal region or spatial region are used, for example, for collision avoidance in autonomous or semi-autonomous vehicles or for monitoring buildings or outdoor areas against unauthorized intrusion. Furthermore, such sensors can be used to trigger specific events, such as for activating a barcode reading device or RFID reading device (RFID: Radio Frequency Identification) in a portal in which, for example, certain properties of packages are determined. When the packages are transported to the portal by means of a conveyor belt, a lidar sensor detects the respective entry of the packages into a predefined zone in front of the portal and the reading devices in the portal are activated accordingly by means of the lidar sensor before the respective package reaches the portal.

To be able to reliably detect the presence of certain objects in a zone by means of such a sensor, it is necessary to mask or disregard objects that fall below a certain size or whose dimensions are below a certain value. Such objects with a small size are called interference objects. Conversely, only those objects should be detected in a certain zone by means of the sensor that have a certain size or in which at least one dimension exceeds a certain value. If the sensor is configured to determine at least one dimension of an object, certain parameters can, for example, be defined during the evaluation of signals detected by the sensor such that only the desired objects whose size exceeds a predefined value are detected in the zone to be monitored.

With certain sensors, for example those based on lidar systems, a discrete scanning of objects within the predetermined zone or the zone to be monitored takes place with individual beams. With such sensors, the size or at least one dimension of objects is determined by the spatial distance of at least two beams at a certain distance of the respective object with respect to the sensor. Due to the divergence of the discrete beams, the number of beams incident on an object depends on the distance and the lateral position of the object with respect to the sensor. The number of beams incident on the object can decrease and increase abruptly when the distance and the lateral position of the object change since, for example, one or more beams that are initially incident on the object can pass by the object when the distance between the object and the sensor increases and/or when the object shifts laterally. As a result, the determined size or dimension of the object fluctuates in dependence on the distance and the lateral position of the object with respect to the sensor.

If the minimum dimension or size from which an object can be detected by means of the sensor in the predetermined zone is almost as large as the size or dimension of the object and the object moves with respect to the sensor, the object is detected at specific distances with respect to the sensor, while it is masked as an interference object at other distances. If the sensor outputs either a free or an occupied state of the zone to be monitored as an output signal, the output state for the zone to be monitored can thus change between “free” and “occupied” at short time intervals. This can be described as a “flickering” of the monitoring state for the zone to be monitored. However, such a rapid temporal change between the “free” and “occupied” states is problematic, in particular, for example, when a sensor that is integrated in an autonomous vehicle and an obstacle on the road approach one another and the monitoring state determined by the sensor influences the braking process of the autonomous vehicle.

An object of the invention comprises providing a sensor that enables a temporally robust and reliable monitoring of a predetermined zone with regard to the presence of at least one object.

This object is satisfied by a sensor having the features of claim 1. Advantageous further embodiments of the invention are set forth in the dependent claims, in the description and in the drawings.

The sensor is provided for monitoring a zone with regard to the presence of at least one object and comprises a transmission device, a reception device and an evaluation device. The transmission device emits transmission signals into the zone to be monitored. The reception device receives detection signals that comprise those transmission signals that are reflected or remitted in the zone to be monitored. The evaluation device is configured to determine at least one measurement variable based on the detection signals, said measurement variable being related to at least one dimension of an object in the zone to be monitored. The evaluation device is further configured to determine and output an occupied state of the zone to be monitored if the at least one measurement variable is greater than an entry threshold value, and to determine and output a free state of the zone to be monitored if the at least one measurement variable is smaller than an exit threshold value. The exit threshold value is different from the entry threshold value.

The zone to be monitored can be an areal region or a spatial region in the immediate or wider vicinity of the sensor. The free state can first be assumed as the initial state for the output by the sensor, i.e., for example, when the sensor is put into operation and was not yet able to detect an object in the zone to be monitored. The evaluation device can determine and output that the zone to be monitored changes from the free state to the occupied state if the measurement variable related to at least one dimension of an object is greater than the entry threshold value, and that the zone to be monitored changes from the occupied state to the free state if the measurement variable is smaller than the exit threshold value.

Such changes between the output of the occupied state and the free state of the zone to be monitored can occur, for example, if the zone to be monitored is continuously monitored by means of the sensor by repeatedly emitting the transmission signals at a certain frequency and by detecting the detection signals accordingly in order to constantly redetermine the measurement variable. This can, for example, take place with repeated scans of a lidar sensor. However, the switch to indicating the occupied state only ever takes place if the measurement variable exceeds the entry threshold value, while the switch to indicating the free state only ever takes place if the measurement variable falls below the exit threshold value.

Due to the limited measurement accuracy of the detection signals, which is given, for example, by a specific signal-to-noise ratio, the evaluation device respectively detects the occupied state and the free state of the zone to be monitored, if applicable, even if the measurement variable is equal to the entry threshold value or exit threshold value. According to one embodiment, it can also be deliberately specified that the occupied state and the free state of the zone to be monitored are also detected or indicated if the measurement variable is equal to the entry threshold value or exit threshold value.

The measurement variable can be, for example, a dimension of the object, said dimension being estimated based on the detection signals, or a number of discrete beams that are emitted by the transmission device and remitted or reflected at at least one object within the zone. The angular distance of the emitted beams defines the resolution of the sensor and the number of reflected or remitted beams is therefore related to the actual dimension of an object in the zone to be monitored.

In the first case, in which the estimated dimension or size of the object is considered, the estimated dimension of all the objects detectable in the zone to be monitored must, for example, fall below a predetermined value that represents the exit threshold value so that the evaluation device determines and outputs that the zone to be monitored has the free state or transitions from the occupied state to the free state. Conversely, to detect the occupied state or a transition to this state by means of the evaluation device, it is necessary, for example, that the estimated dimension of at least one object exceeds another, for example larger, predetermined value that represents the entry threshold value.

In the second case, in which the number of detected beams is considered, the number of discrete beams that are reflected or remitted at at least one object must be smaller than a predetermined number so that the evaluation device determines and outputs that the zone to be monitored has the free state or transitions to this state. The predetermined number of discrete beams can, for example, be one or two or another small integer and thus represents the exit threshold value. Conversely, to detect the occupied state or a transition to this state by means of the evaluation device, it is necessary for the number of detected discrete beams to exceed a predetermined value that represents the entry threshold value.

The term entry threshold value is intended to symbolize that at least one object must first have entered the zone to be monitored so that the sensor can detect the occupied state. Conversely, the term exit threshold value is intended to symbolize that all objects that exceed a predetermined size and could be present in the zone to be monitored must have exited the zone so that the sensor can detect the free state.

One advantage of the sensor is that two different limit values are used to indicate the occupied state or the free state of the zone to be monitored by means of the sensor. For the detection of the occupied state, the predetermined entry threshold value can be selected sufficiently large so that interference objects are masked that can cause the evaluation device to falsely indicate the occupied state of the zone to be monitored. For the detection of the free state or for the transition from the occupied state to the free state, another predetermined value is, however, provided with which, for example, the estimated dimension of the object or another measurement variable derived from the detection signals and related to the actual dimension of the object is compared.

It can thereby be ensured that the detection of the free state of the zone or the transition to the free state takes place under conditions that are independent of, for example, a minimum size of objects that are to be detected within the zone to be monitored. For example, it can only be allowed that the evaluation device indicates the free state of the zone to be monitored or indicates a transition into it if only those objects whose dimensions are significantly smaller than the entry threshold value are detected in the zone, or if the number of discrete beams that are reflected or remitted at objects within the zone is almost zero. The evaluation device can thereby be prevented from outputting a rapid change between the occupied state and the free state of the zone to be monitored, in particular if the object moves with respect to the sensor. The occupied state and free state of the zone to be monitored can therefore in each case be detected by means of the sensor in a temporally robust manner without rapid fluctuations.

According to one embodiment, the measurement variable can comprise a value for a dimension (hereinafter also an “estimated dimension”) of the object, which value is estimated based on the detection signals. In this embodiment, the entry threshold value can comprise a first predetermined length, while the exit threshold value can comprise a second predetermined length. The first predetermined length can be greater than the second predetermined length. The exit threshold value can, for example, be defined as a predetermined percentage of the entry threshold value. The entry threshold value can be defined in the range of a minimum object size to be expected.

Since in this embodiment the occupied state of the zone to be monitored or the transition into it is indicated by means of the evaluation device for an estimated dimension of the object above the entry threshold value or the first length, while the free state or a transition into it is only indicated by means of the evaluation device for an estimated dimension of the object below the smaller exit threshold value or the smaller second length, a hysteresis is predefined for the detection of the free or occupied state or for the transitions between them by means of the sensor. This hysteresis prevents rapid changes between the indication of the free and the occupied state of the zone to be monitored, and thus a “flickering” when determining and outputting the monitoring state of the zone by means of the sensor, even if the object moves with respect to the sensor.

Furthermore, in this embodiment, in addition to the estimated dimension of the object, no further variable needs to be derived from the detection signals to indicate the free or occupied state or a transition between them by means of the sensor. This reduces the effort when evaluating the detection signals.

The sensor can comprise a lidar sensor that transmits the transmission signals as beams with at least a predetermined angular distance between them into the zone to be monitored. The entry threshold value and the exit threshold value can be defined based on the at least one angular distance. The transmission signals can thus be configured as discrete beams of the lidar sensor that cover the areal region or spatial region to be monitored. Since the predetermined angular distance defines the resolution of the lidar sensor, the entry threshold value and the exit threshold value can thus be adapted to the resolution of the lidar sensor by the definition based on the predetermined angular distance. The robustness of the sensor when determining the free or occupied state of the zone to be monitored can thereby be improved.

The lidar sensor can further be configured as a multi-layer sensor in which the angular distance between a plurality of adjacent beams is different in a horizontal direction and in a vertical direction. The evaluation device can further be configured to determine a horizontal dimension and a vertical dimension of the object in the zone to be monitored based on the detection signals. The entry threshold value and the exit threshold value can, in dependence on the respective angular distance of adjacent beams, have respective values that are different from one another for the horizontal direction and the vertical direction.

Furthermore, the evaluation device can in this respect be configured to determine and output an occupied state of the zone to be monitored if the horizontal dimension or the vertical dimension of the object is greater than the respective entry threshold value for the horizontal direction or the vertical direction, and to determine and output a free state of the zone to be monitored if the horizontal dimension and the vertical dimension of the object are smaller than or equal to the respective exit threshold value for the horizontal direction and the vertical direction.

The angular distance between adjacent beams can be smaller in the horizontal direction than in the vertical direction. Accordingly, a difference between the entry threshold value and the exit threshold value can be smaller for the horizontal direction than for the vertical direction.

If the lidar sensor is configured as a multi-layer sensor, it can thus, for example, have a different resolution in two directions arranged at right angles to one another, wherein the resolution in the horizontal direction can be considerably higher than in the vertical direction. The entry threshold value and the exit threshold value for the detection or indication of the occupied or free state of the zone to be monitored can each have different values such that they are adapted to the direction-dependent resolution or the direction-dependent angular distance between adjacent beams of the multi-layer sensor. Consequently, the entry threshold value and the exit threshold value are not constant values, but can change over time and/or have a different value for different dimensions, for example for the horizontal direction and the vertical direction.

If the exit threshold value is defined relative to the entry threshold value, the exit threshold value for the horizontal direction with a high resolution or a small angular distance between adjacent beams can, for example, be 90% of the entry threshold value, while the exit threshold value for the vertical direction with a lower resolution or a larger angular distance between adjacent beams can be only 50% of the corresponding entry threshold value. In other words, the entry threshold value and the exit threshold value for the horizontal direction have almost identical values, while they can differ significantly from one another for the vertical direction, here for example by a factor of 2.

The evaluation device can be configured to define the exit threshold value based on an estimated minimum value for the at least one dimension of the object. Specifically, the exit threshold value can be defined such that it is smaller than the estimated minimum value for the at least one dimension of the object and is, for example, approximately 90% of this value. It can thereby be ensured that the evaluation unit always determines an occupied state for the zone to be monitored as soon as an object at any position within the zone to be monitored exceeds the estimated minimum value for one of its dimensions.

A position-dependent error for estimating the dimension of the object can additionally be determined within the zone to be monitored based on the detection signals. Specifically, for example for a sensor that emits discrete beams, an error can be indicated for the estimation of the dimension in dependence on the distance between the object and the sensor. The estimated minimum value for the at least one dimension of the object can be based on the determination of this position-dependent error and can thus likewise depend on the position within the zone to be monitored.

The entry threshold value and the exit threshold value can further be designed as configurable by a user. In such a configuration, the entry threshold value should preferably be set based on a minimum size of an object to be expected, for which size the sensor should indicate an occupied state of the zone to be monitored. However, the exit threshold value should preferably be set such that, on the one hand, there is no rapid change between the detection or indication of the “free” and “occupied” states for the zone to be monitored since the exit threshold value is set too large, and such that, on the other hand, there is no unnecessary susceptibility to interference objects since the exit threshold value is set too small.

According to a further embodiment, in which the sensor is again configured as a lidar sensor that transmits the transmission signals as beams with at least a predetermined angular distance between them into the zone to be monitored, the at least one measurement variable can comprise a number of those beams that are reflected or remitted at at least one object in the zone to be monitored. The entry threshold value can comprise a first predetermined number of detected beams, while the exit threshold value can comprise a second predetermined number of detected beams. In this respect, the first predetermined number is greater than the second predetermined number.

In this embodiment, the evaluation device can thus be configured to determine the occupied and free state of the zone to be monitored in each case when the number of beams reflected or remitted at the at least one object is greater or smaller than a respective predetermined number. In the simplest case, the first predetermined number can be set to one so that the detection or indication of the free state or a change from “occupied” to “free” only takes place if no beam of the transmission signal is incident on an object within the zone to be monitored. Alternatively, the predetermined number can be set to a small integer, for example to two or three, so that a maximum of only one or two beams may be incident on one or more objects so that the free state or the change from “occupied” to “free” for the zone to be monitored is determined and output by means of the evaluation device. The robustness when determining the correct state of the zone to be monitored with respect to interference objects is thereby increased.

According to yet a further embodiment, in which the sensor is again configured as a lidar sensor that transmits the transmission signals as beams with at least a predetermined angular distance between them into the zone to be monitored, the at least one measurement variable can comprise a dimension of the object estimated by means of the detection signals and a number of those beams that are reflected or remitted at at least one object in the zone to be monitored. The entry threshold value can comprise a predetermined length, while the exit threshold value can comprise a predetermined number of detected beams. Alternatively, the entry threshold value can comprise a first predetermined number of detected beams, while the exit threshold value can comprise a predetermined length.

In this embodiment, two measurement variables are thus determined based on the detection signals, namely an estimated dimension or size of at least one object and a number of beams reflected or remitted at at least one object. Furthermore, a respective one of the threshold values, i.e. the entry or exit threshold value, can be related to one of the two measurement variables to determine and output the occupied or free state of the zone to be monitored.

The evaluation device can additionally be configured to determine and output the free state of the zone to be monitored, or to change to a “free” monitoring state to be output, only if two beams reflected or remitted within the zone are not adjacent beams. In other words, between two such beams there must be at least one further beam that is not reflected or remitted at any object within the zone to be monitored. The number of beams reflected or remitted within the zone to be monitored that are detected is thus at least two in this embodiment. If the two beams reflected or remitted within the zone are not adjacent beams, this reflection or remission occurs randomly, i.e. with a high probability at two interference objects that are not to be detected in the zone to be monitored. In this embodiment, the robustness against interference objects is thus further improved.

According to a further embodiment, the evaluation device can further be configured to determine a plurality of values of the measurement variable, in each case based on the detection signals, for a plurality of consecutive points in time. The evaluation device can determine that the zone to be monitored has the occupied state or transitions from the free state to the occupied state if a predetermined number of consecutive values for the at least one dimension of the object, i.e. for the plurality of consecutive points in time, is greater than the entry threshold value, and said evaluation device can determine that the zone to be monitored has the free state or transitions from the occupied state to the free state if a predetermined number of consecutive values of the measurement variable, i.e. for a plurality of consecutive points in time, is smaller than the exit threshold value.

This embodiment thus uses the principle of multiple evaluation of the detection signals for a plurality of points in time that follow one another. In this embodiment, the number of values determined by means of the evaluation device that exceed the entry threshold value or fall below the exit threshold value must therefore be greater than a respective predetermined number so that a change from “free” to “occupied” or, vice versa, for the state of the zone to be monitored can be determined and output by means of the evaluation device. This improves the robustness of the sensor and of the evaluation of the state of the zone to be monitored with respect to random fluctuations and interference objects.

A further subject of the invention is a method for monitoring a zone with regard to the presence of at least one object. According to the method, transmission signals are emitted into the zone to be monitored and detection signals are received that comprise those transmission signals that are reflected or remitted in the zone to be monitored. At least one measurement variable is determined based on the detection signals, said measurement variable being related to at least one dimension of an object in the zone to be monitored. An occupied state of the zone to be monitored is determined and output when the at least one measurement variable is greater than an entry threshold value, whereas a free state of the zone to be monitored is determined and output when the at least one measurement variable is smaller than an exit threshold value. The exit threshold value is different from the entry threshold value.

The statements regarding the sensor apply accordingly to the method; this in particular applies with respect to advantages and embodiments. It is furthermore understood that all the features mentioned herein can be combined with one another, unless explicitly stated otherwise.

The invention will be described in the following by way of example with reference to advantageous embodiments and to the enclosed Figures. There are shown, schematically in each case:

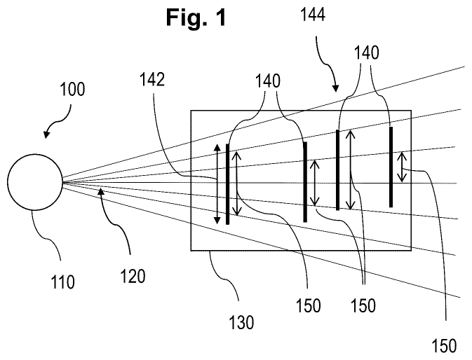

FIG. 1 a representation of a sensor for monitoring a predetermined zone;

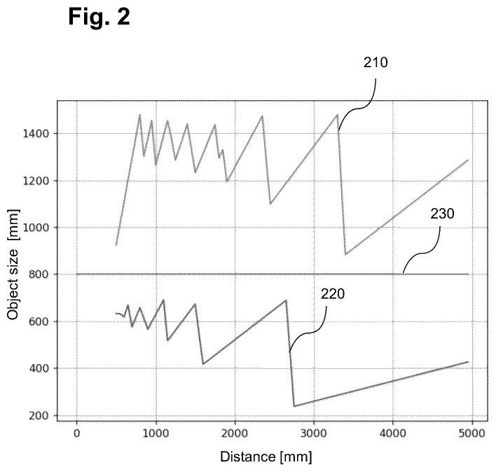

FIG. 2 a diagram that represents the determination of an object size in dependence on the distance of the object,

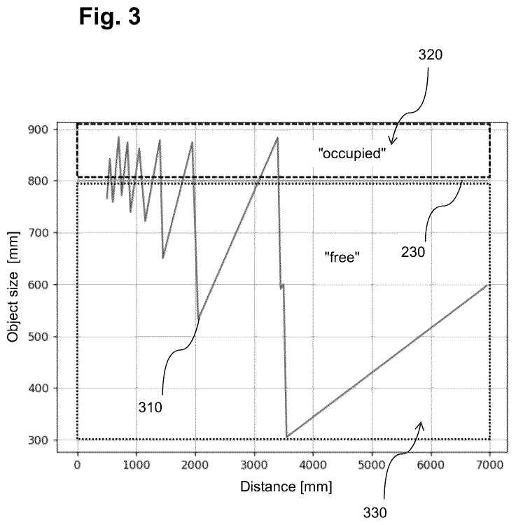

FIG. 3 a further diagram that represents the determination of the object size in dependence on the distance of the object, and

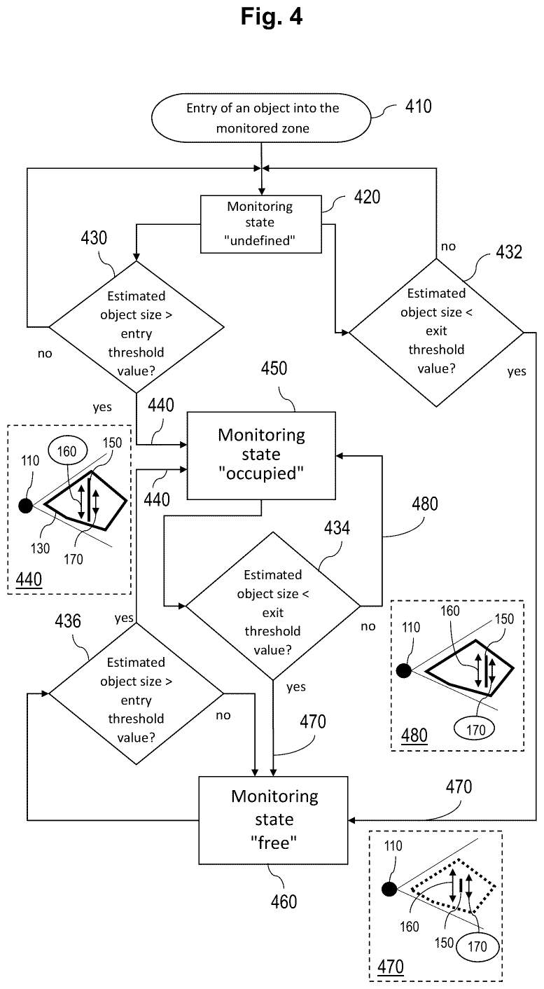

FIG. 4 a state diagram for illustrating a method for monitoring a predetermined zone.

FIG. 1 schematically shows a sensor 100 that is configured as a lidar system and has a transmission device 110 that emits transmission signals in the form of discrete measurement beams 120 into a zone 130 to be monitored. By means of the transmission device 110, a discrete scanning of the zone 130 by the measurement beams 120 thus takes place. The sensor 100 is provided to monitor the zone 130 with regard to the presence of at least one object 140 that, for the sake of simplicity, is illustrated by a line in FIG. 1. In FIG. 1, the object 140 is shown at various positions within the zone 130 to be monitored, at each of which the object 140 has different distances and different lateral positions with respect to the sensor 100. An actual size or dimension of the object 140 is illustrated by the arrow 142.

The sensor 100 further comprises a reception device, not shown, that receives detection signals that comprise reflected or remitted transmission signals. The transmission signals 120 are reflected or remitted at the object 140 within the zone 130 to be monitored to generate the detection signals that are received by the reception device of the sensor.

The sensor 100 further has an evaluation device, not shown, that is configured to determine a measurement variable in the form of at least one estimated dimension 150 of the object 140 in the zone 130 to be monitored based on the detection signals. Specifically, the evaluation device determines the estimated dimension 150 based on a distance or a length between the two outermost measurement beams 120 that are each incident on the object 140. The length 150, which corresponds to the estimated dimension of the object 140 in a spatial direction, is shown in FIG. 1 in each case as a double arrow for different distances of the object 140 with respect to the sensor 100.

As can be seen in FIG. 1, the estimated object size or dimension 150 of the object 140 changes with its distance with respect to the sensor 100, although the object 140 has the constant actual size or dimension 142. The reason for this fluctuation in the estimated dimension 150 of the object 140 is that the estimation of the dimension 150 takes place using the acquired lidar data with discrete angular distances between the measurement beams 120, wherein the distance between the points of intersection of two measurement beams 120 and the object 140 at the respective distance with respect to the sensor 100 is determined as the estimated dimension 150. Due to the limited angular resolution or the finite angular distances between the discrete measurement beams 120, it is usually not possible to detect exact points of intersection between an imaginary beam emanating from the sensor 100 and a respective edge of the object 140.

The fluctuation of the estimated object size or dimension 150 of the object 140 with its distance with respect to the sensor 100 is illustrated in the diagram shown in FIG. 2. The diagram shows the object size or dimension 150 of the object 140 estimated by means of the sensor 100 in dependence on the respective distance of the object 140 with respect to the sensor 100. The upper curve 210 in FIG. 2 was determined for an object 140 with a real size or dimension 142 of 1500 mm.

As can be seen, the curve 210 assumes as maximum values, for instance, the real object size or dimension of approximately 1500 mm, and indeed when the discrete measurement beams 120 intersect the object 140 in a marginal region very close to a respective object edge. This is the case, for example, in FIG. 1—viewed from the left—at the third distance of the object 140 that is designated as 144.

Between the respective distances with respect to the sensor 100 at which, for instance, the real object size or dimension of the object 140 is estimated, the curve 210 for the estimated object size or dimension 150 of the object 140 exhibits significant fluctuations that increase with the distance of the object 140 with respect to the sensor. In FIG. 2, the maximum fluctuation of the curve 210 is approximately 600 mm. The estimated object size or dimension 150 of the object 140 thus has a position-dependent error that depends on the distance between the object 140 and the sensor 100, and thus on the position of the object 140 within the monitored zone 130, and has a maximum value of approximately 600 mm.

However, the sensor 100 is provided for monitoring the zone 130 only with regard to the presence of objects 140 so that an exact determination of the object size or the dimension of the object 140 is not necessary. Instead, the sensor 100 should only detect whether an object 140 with a certain object size or dimension is present in the zone 130, or not.

When detecting objects 140 in this way, objects that fall below a certain size or dimension and are called interference objects should be masked, however. In the example of FIG. 2, in addition to the curve 210, which is assigned to an object 140 to be detected, a curve 220 is shown that is assigned to an interference object with an object size or dimension of 700 mm and that indicates an estimated size or dimension of the interference object. As can again be seen in FIG. 2, the curve 220 reaches the real dimension of 700 mm as respective maxima at certain distances of the interference object with respect to the sensor 100. A considerable fluctuation in the estimated object size or dimension of the interference object in dependence on the distance occurs between these maxima.

To detect, by means of the sensor, only those objects 140 in the zone 130 whose presence in this zone 130 is actually expected and to mask the influence of interference objects, a threshold value is usually defined for a minimum dimension of the objects 140 that are to be detected in the zone 130. In other words, only those objects 140 whose object size or dimension exceeds this threshold value for the minimum dimension of the object 140 are considered when monitoring the zone 130 by means of the sensor 100.

In FIG. 2, such a threshold value 230 is shown by the horizontal line at an object size of 800 mm. Consequently, in the example of FIG. 2, only those objects 140 whose estimated object size or dimension 150 is greater than 800 mm are considered when monitoring the zone 130. The interference object with a real object size of 700 mm is, instead, not considered when monitoring the zone 130 since its estimated object size, which is represented by the curve 220, is always below the threshold value 230.

For the object 140 that is assigned to the curve 210 of FIG. 2 and that has an object size or dimension of 1500 mm, the evaluation device of the sensor 100 can clearly determine and output an occupied state of the zone 130 to be monitored since the dimension of the object 140, irrespective of its distance with respect to the sensor 100, is always estimated as greater than the threshold value 230 of 800 mm. In other words, the entry of an object 140, whose estimated dimension is represented by the curve 210 of FIG. 2, into the zone 130 always results in the evaluation device indicating an occupied state of the zone 130 to be monitored.

Conversely, the evaluation device of the sensor 100 always determines a free state of the zone 130 to be monitored for the interference object that is assigned to the curve 220 of FIG. 2 and that has a real object size or dimension of 700 mm, since the estimated dimension or object size according to the curve 220 is below the threshold value 230 of 800 mm for all distances with respect to the sensor 100. In other words, the object sizes of the object 140 whose presence or entry into the zone 130 to be monitored is to be detected and of the interference object are different such that the interference object and the object 140 to be detected are distinguishable from one another.

However, if the object sizes of an object 140 to be detected and of an interference object are in a similar range and the object size of an object 140 is in particular only slightly above the threshold value 230, interference objects and objects 140 to be detected may no longer be distinguishable. For a specific object, the evaluation device may no longer be able to clearly indicate whether the zone 130 to be monitored assumes an occupied or a free state due to this object.

Such behavior is illustrated in FIG. 3. As for FIG. 2, a threshold value 230 of 800 mm is used for a minimum object size. Furthermore, an object with a real object size 142 of 900 mm is assumed for the estimation of the object size or dimension in FIG. 3. Objects 140 with an object size or dimension greater than the threshold value 230 should thus again be regarded as objects to be detected for which the evaluation device of the sensor 100 should determine an occupied state of the zone 130 to be monitored. The estimated object size or dimension 150 for the object 140 with a real dimension of 900 mm is shown in FIG. 3 in dependence on the distance of the object 140 with respect to the sensor 100 by the curve 310.

As can be seen in FIG. 3, the curve 310 again assumes maximum values in the range of the real object size or dimension of 900 mm at certain distances. However, between these maxima, the estimation of the object size fluctuates significantly depending on the distance of the object 140 with respect to the sensor 100. When determining the curve 310, an angular distance of the beams of the lidar system of 5° was assumed. This corresponds to the typical angular distance of a multi-layer lidar sensor.

Furthermore, FIG. 3 shows a range 320 above the threshold value 230 of 800 mm for which the evaluation device of the sensor 100 determines an occupied state of the zone 130 to be monitored. Accordingly, the evaluation device of the sensor 100 determines a free state of the zone 130 to be monitored in a range 330 below the threshold value 230.

Since the curve 310 lies above the threshold value 230 or in the range 320 of the occupied state for some distance ranges and below the threshold value 230 or in the range 330 of the free state of the zone 130 to be monitored for other distance ranges, whether the evaluation device of the sensor 100 indicates a free or an occupied state of the zone 130 to be monitored, depends, for the example of FIG. 3, on the specific distance of the object 140 with respect to the sensor 100. Consequently, for the example of FIG. 3, the evaluation device is not able to clearly indicate the occupied or free state of the zone 130 to be monitored since the object size of 900 mm differs by only 100 mm from the threshold value 230 of 800 mm and the fluctuations in the estimated object size 150 are significantly greater than the difference of 100 mm between the actual object size 142 and the threshold value 230.

If the object 140 with a real object size of 900 mm moves beyond this within the zone 130 to be monitored, the estimated object size or dimension 150 of the object 140 is above the threshold value 230 in the range 320 of the occupied state for certain points in time and below the threshold value 230 in the range 330 of the free state for other points in time, as soon as the distance of the object 140 or also the lateral position of the object 140 changes when it moves. Therefore, during a movement of the object 140, the estimation of the object size according to the example of FIG. 3 can cause the evaluation device of the sensor 100 to determine, during the movement of the object 140, a rapid change between the occupied state and the free state of the zone 130 to be monitored. This rapid temporal change is also referred to as a “flickering” of the monitoring state of the zone 130. If the sensor 100 is, for example, used in an autonomous vehicle, it can, for example, be problematic during a braking process of such an autonomous vehicle if the monitoring state of a zone that is located outside such an autonomous vehicle changes quickly or flickers between the “free” and “occupied” states.

To avoid such rapid changes between the determination of the occupied state and the free state for the zone 130 to be monitored, a method according to the invention or a configuration according to the invention of the evaluation device of the sensor 100 is provided, as are shown in FIG. 4.

At 410, the entry of an object 140 into the zone to be monitored or the monitored zone 130 takes place. As indicated at 420, the monitoring state of the zone 130 is undefined at this point in time. Alternatively, it can also be assumed that the monitoring state first has a free initial state since no object 140 was previously located in the monitored zone 130.

The transmission device 110 of the sensor 100 (cf. FIG. 1 and in FIG. 4 the additional representations in the dashed blocks 440, 470 and 480) emits transmission signals in the form of the measurement beams 120 into the monitored zone 130 and the reception device of the sensor 100 receives detection signals that comprise those transmission signals that are reflected or remitted in the monitored zone 130.

Based on the detection signals, the evaluation device of the sensor 100 determines an estimated object size or at least an estimated dimension 150 of the object 140. The evaluation device of the sensor 100 compares the estimated object size 150 at 430 with an entry threshold value 160 and at 432 with an exit threshold value 170 (cf. the dashed blocks 440 and 470).

If the estimated object size at 430 is greater than the entry threshold value 160, the evaluation device of the sensor 100 determines an occupied state 450 of the monitored zone 130 and outputs the occupied state 450. However, if the estimated object size at 430 is smaller than the entry threshold value 160, the undefined monitoring state 420 remains.

The fact that the condition for the transition to the output of the occupied state 450 or for the transition to the “occupied” monitoring state is fulfilled at 430, is designated as 440 in FIG. 4 and is additionally illustrated in the dashed block 440. The block 440 shows the transmission device 110 of the sensor 100 with its field of view that is shown by two boundary lines and that covers the monitored zone 130. In addition, the estimated object size or dimension 150 is shown that is determined by means of the evaluation device of the sensor 100.

Block 440 further shows that the estimated object size or dimension 150 of the object 140 is greater than the entry threshold value 160 that is illustrated by a double arrow. Therefore, the occupied state 450 is indicated for the monitored zone 130. Since the comparison of the estimated object size or dimension 150 of the object 140 with the entry threshold value 160 is decisive for the transition to the output of the occupied state 450, the reference sign 160 in block 440 is highlighted with a border. The occupied state is further illustrated in block 440 by a solid boundary line of the monitored zone 130.

However, if the estimated object size at 432 is smaller than the exit threshold value 170, the evaluation device of the sensor 100 determines a free state 460 of the monitored zone 130 and outputs the free state 460. If the estimated object size at 432 is greater than the exit threshold value 170, however, the undefined monitoring state 420 remains.

The fact that the condition for the transition to the output of the free state 460 or for the transition to the “free” monitoring state is fulfilled at 432, is designated as 470 in FIG. 4 and is additionally illustrated in the dashed block 470. Just like the block 440, the block 470 shows the transmission device 110 of the sensor 100 with its field of view, the monitored zone 130, the estimated object size or dimension 150 and the entry and exit threshold value 160 and 170.

Block 470 further shows that the estimated object size or dimension 150 of the object 140 is smaller than the exit threshold value 170 that is again illustrated by a double arrow. Therefore, the free state 460 is indicated for the monitored zone 130. Since the comparison of the estimated object size or dimension 150 of the object 140 with the exit threshold value 170 is decisive for the transition to the output of the free state 460, the reference sign 170 in block 470 is highlighted with a border. The free state is illustrated in block 470 by a dotted boundary line of the monitored zone 130.

After either the occupied state 450 or the free state 460 of the monitored zone 130 has been determined for the first time, the monitored zone 130 continues to be monitored by means of the sensor 100 (cf. FIG. 1), e.g. by means of further scans of a lidar sensor. Each new scan provides further detection signals that enable a new or iterative determination of the estimated object size or dimension 150 of the object 140. Therefore, in the blocks 434 and 436, it is again checked, in each case starting from the current indication of the occupied state 450 or the free state 460, whether the newly estimated object size or dimension 150 of the object 140 is smaller than the exit threshold value 170 or greater than the entry threshold value 160. It is thereby determined whether a transition from “occupied” to “free”, or vice versa, should take place when the monitoring state is indicated.

When the occupied state 450 of the monitored zone 130 has been determined, it is checked at 434 whether the estimated object size or dimension 150 of the object 140 is smaller than the exit threshold value 170. If this is not the case and the estimated object size or dimension 150 is thus greater than the exit threshold value 170, the evaluation device of the sensor 100 continues to output the occupied state 450 of the monitored zone 130.

The maintenance of the output of the occupied state 450 for the monitored zone 130 is designated as 480 and is additionally illustrated in the dashed block 480. Just like the blocks 440 and 470, the block 480 shows the transmission device 110 of the sensor 100 with its field of view, the monitored zone 130, the estimated object size or dimension 150 and the entry and exit threshold value 160 and 170.

In block 480, the estimated object size or dimension 150 of the object 140 is smaller than the entry threshold value 160, but greater than the exit threshold value 170 that is defined smaller than the entry threshold value 160. Therefore, the evaluation device of the sensor 100 continues to output the occupied state 450 for the monitored zone 130. The occupied state is again illustrated by the solid boundary line of the monitored zone 130.

However, if the estimated object size 150 at 434 is smaller than the exit threshold value 170, the evaluation device of the sensor 100 determines the free state 460 of the monitored zone 130 and outputs the free state 460. The fact that the condition for the transition to the output of the free state 460 or for the transition to the “free” monitoring state is fulfilled at 434, is again designated as 470. This condition is likewise additionally illustrated in the dashed block 470. Due to the fulfilled condition 470, a change from “occupied” to “free” thus takes place after 434 when outputting the monitoring state.

However, if the free state 460 of the monitored zone 130 was previously determined and output, it is checked at 436 whether the estimated object size or dimension 150 of the object 140 is greater than the entry threshold value 160. If this is the case and the estimated object size or dimension 150 is thus greater than the entry threshold value 160, the evaluation device of the sensor 100 outputs the occupied state 450 of the monitored zone 130.

In other words, if the condition of block 436 is fulfilled, a change from “free” to “occupied” takes place when outputting the monitoring state. This is again illustrated in block 440 that shows that the estimated object size or dimension 150 of the object 140 is greater than the entry threshold value 160.

However, if the estimated object size 150 at 436 is smaller than the entry threshold value 160, the evaluation device of the sensor 100 continues to determine the free state 460 of the monitored zone 130 and outputs the free state 460. In this case, the estimated object size 150 can either be smaller than the exit threshold value 170, as illustrated at 470, or greater than the exit threshold value 170 and simultaneously smaller than the entry threshold value 160, as is shown at 480. The entry threshold value 160 thus defines a minimum object size that must be detected in the monitored zone to determine the occupied state 450 for the monitored zone.

Since the exit threshold value 170 is defined as smaller than the entry threshold value 160, the detection of the free and occupied state of the monitored zone 130 and the detection of a transition between the occupied state and the free state, and vice versa, takes place with a hysteresis. A rapid change or a flickering between the indication of the occupied state and the free state, or vice versa, thereby takes place. Thus, the state of the monitored zone 130 can be indicated in a reliable or temporally robust manner by means of the evaluation device of the sensor 100.

### REFERENCE NUMERAL LIST

100 sensor
110 transmission device
120 measurement beam
130 zone to be monitored
140 object
142 actual dimension or size of the object
144 specific distance of the object with respect to the sensor
150 estimated object size or dimension of the object
160 entry threshold value
170 exit threshold value
210 curve for the estimated object size of an object to be detected
220 curve for the estimated object size of an interference object
230 threshold value for the object size
310 curve for the estimated object size of a specific object
320 range for the occupied state
330 range for the free state
410 entry of an object into the monitored zone
420 undefined monitoring state
430 comparison of the object size with the entry threshold value
432 comparison of the object size with the exit threshold value
434 comparison of the object size with the exit threshold value
436 comparison of the object size with the entry threshold value
440 condition for the transition to the occupied monitoring state fulfilled
450 occupied monitoring state
460 free monitoring state
470 condition for the transition to the free monitoring state fulfilled
480 condition for the maintenance of the occupied monitoring state fulfilled

1. A sensor for monitoring a zone with regard to the presence of at least one object, said sensor comprising:
a transmission device that emits transmission signals into the zone to be monitored,
a reception device that receives detection signals that comprise transmission signals reflected or remitted in the zone to be monitored, and
an evaluation device that is configured:
to determine at least one measurement variable based on the detection signals, said measurement variable being related to at least one dimension of an object in the zone to be monitored,
to determine and output an occupied state of the zone to be monitored if the at least one measurement variable is greater than an entry threshold value, and
to determine and output a free state of the zone to be monitored if the at least one measurement variable is smaller than an exit threshold value,
wherein the exit threshold value is different from the entry threshold value.

2. The sensor according to claim 1,
wherein
the at least one measurement variable comprises a dimension of the object, said dimension being estimated based on the detection signals,
the entry threshold value comprises a first predetermined length and the exit threshold value comprises a second predetermined length, and the first predetermined length is greater than the second predetermined length.

3. The sensor according to claim 2,
wherein
the sensor comprises a lidar sensor that transmits the transmission signals as beams with at least a predetermined angular distance between them into the zone to be monitored, and
the entry threshold value and the exit threshold value are defined based on the at least one predetermined angular distance.

4. The sensor according to claim 3,
wherein
the lidar sensor is configured as a multi-layer sensor in which the angular distance between adjacent beams is different in a horizontal direction and in a vertical direction,
the evaluation device is further configured to determine a horizontal dimension and a vertical dimension of the object in the zone to be monitored based on the detection signals,
the entry threshold value and the exit threshold value have respective values in dependence on the respective angular distance of adjacent beams, said respective values being different from one another for the horizontal direction and the vertical direction, and
the evaluation device is further configured:
to determine and output an occupied state of the zone to be monitored if the horizontal dimension or the vertical dimension of the object is greater than or equal to the respective entry threshold value for the horizontal direction or the vertical direction, and
to determine and output a free state of the zone to be monitored if the horizontal dimension and the vertical dimension of the object are smaller than or equal to the respective exit threshold value for the horizontal direction and the vertical direction.

5. The sensor according to claim 4,
wherein
the angular distance between adjacent beams in the horizontal direction is smaller than in the vertical direction and
a difference between the entry threshold value and the exit threshold value for the horizontal direction is smaller than for the vertical direction.

6. The sensor according to claim 1,
wherein
the sensor comprises a lidar sensor that transmits the transmission signals as beams with at least a predetermined angular distance between them into the zone to be monitored,
the at least one measurement variable comprises a number of beams that are reflected or remitted at at least one object in the zone to be monitored,
the entry threshold value comprises a first predetermined number of beams and the exit threshold value comprises a second predetermined number of beams, and
the first predetermined number is greater than or equal to the second predetermined number.

7. The sensor according to claim 1,
wherein
the sensor comprises a lidar sensor that transmits the transmission signals as beams with at least a predetermined angular distance between them into the zone to be monitored,
the at least one measurement variable comprises an estimated dimension of the object and a number of beams that are reflected or remitted at at least one object in the zone to be monitored, and
the entry threshold value comprises a predetermined length, while the exit threshold value comprises a predetermined number of beams, or the entry threshold value comprises a predetermined number of beams, while the exit threshold value comprises a predetermined length.

8. The sensor according to claim 6,
wherein
the evaluation device is further configured to determine the free state of the zone to be monitored only if two beams reflected or remitted within the zone are not adjacent beams.

9. The sensor according to claim 7,
wherein
the evaluation device is further configured to determine the free state of the zone to be monitored only if two beams reflected or remitted within the zone are not adjacent beams.

10. The sensor according to claim 1,
wherein
the evaluation device is further configured:
to determine a plurality of values of the measurement variable, in each case based on the detection signals, for a plurality of consecutive points in time,
to determine and output that the zone to be monitored has the occupied state if a predetermined number of consecutive values of the measurement variable is greater than the entry threshold value,
to determine and output that the zone to be monitored has the free state if a predetermined number of consecutive values of the measurement variable is smaller than the exit threshold value.

11. A method for monitoring a zone with regard to the presence of at least one object, said method comprising:
transmission signals being emitted into the zone to be monitored,
detection signals being received that comprise transmission signals reflected or remitted in the zone to be monitored,
at least one measurement variable being determined based on the detection signals, said measurement variable being related to at least one dimension of an object in the zone to be monitored,
an occupied state of the zone to be monitored being determined and output if the at least one measurement variable is greater than an entry threshold value, and
a free state of the zone to be monitored being determined and output if the at least one measurement variable is smaller than an exit threshold value,
wherein the exit threshold value is different from the entry threshold value.
